(19) United States
(12) Patent Application Publication
(10) Pub. No.: US 2012/0013751 A1
(43) Pub. Date: Jan. 19, 2012

(54) IMAGE CAPTURING DEVICE AND CONTROL METHOD OF OPERATION MODE THEREOF, AND ELECTRONIC DEVICE USING IMAGE CAPTURING DEVICE

(76) Inventors: Jiing-Horug SHIEH, Hsinchu County (TW); Wen-Han Yao, Hsinchu County (TW)

(21) Appl. No.: 13/182,810

(22) Filed: Jul. 14, 2011

(30) Foreign Application Priority Data
Jul. 16, 2010 (TW) 099123576

(51) Int. Cl. H04N 5/225

(52) U.S. Cl. 348/207.11; 348/207.1; 348/E05.048

(57) ABSTRACT

An image capturing device includes an image capturing unit, a processing unit, a register unit, and at least one triggering unit. The image capturing unit is used for capturing image data; the processing unit is electrically connected to the image capturing unit and is used for executing a comparison procedure; the register unit is electrically connected to the processing unit and is configured with a determination logic; and the triggering unit is electrically connected to the processing unit, in which the processing unit runs the comparison procedure according to at least one of an execution state of the triggering unit and the determination logic, and the processing unit controls an operation mode of the image capturing device according to the comparison procedure.

### CROSS-REFERENCE TO RELATED APPLICATIONS

This non-provisional application claims priority under 35 U.S.C. §119(a) on Patent Application No(s). 099123576 filed in Taiwan, R.O.C. on Jul. 16, 2010, the entire contents of which are hereby incorporated by reference.

### BACKGROUND OF THE INVENTION

1. Field of the Invention

The present invention relates to an image capturing device, and more particularly to an image capturing device having a triggering unit and capable of controlling an operation mode thereof according to an execution state of the triggering unit, an electronic device using the image capturing device, and a control method of the operation mode of the image capturing device.

2. Related Art

With quick changes of technology, various kinds of electronic products gradually become an indispensable part in the life of modern people, and particularly, a portable notebook is the most indispensable. Generally speaking, in order to conform to main market trend, a firmware function in the notebook is developed to be more and more powerful and comprehensive to meet diversity requirements on the notebook for different applications.

Currently most notebooks are equipped with an image capturing function. That is to say, an image capturing device, for example, a web camera, may be configured in the notebook during design, so as to present image data captured by the web camera on a screen of the notebook after an image processing procedure.

However, under the influence of the increasing development of the image processing technology, for the functions executed by the current image processing procedure, the image post-process may be performed on an output frame according to personal fondness of a user, or an objective of changing an image special effect (for example, changing a background color or a background pattern) may be achieved to obtain more abundant image presentation frames.

In the case, after the conventional web camera outputs the image frames onto a display device of the notebook, a user may change the special effect of the output frame using image processing software (for example, graphic software, image processing software or 3D viewing angle simulating software) of the notebook. It can be seen that the operation manner may not only bring considerable inconvenience for the user in an actual condition, but also result in that different image processing software, like the graphic software, the image processing software or the 3D viewing angle simulating software, needs to be additionally installed in the notebook for different special effect in the post-process. Therefore, the complexity of software and hardware of the notebook is increased.

### SUMMARY OF THE INVENTION

Accordingly, the disclosure is an image capturing device and an electronic device using the image capturing device, which reduces usage complexity of a conventional web camera and a notebook using the web camera. In addition, the disclosure is further related to a method, through which a user easily and conveniently performs image special effect change and post-process on an image output frame, and changes an operation mode of the image capturing device.

The disclosure provides an image capturing device, which comprises an image capturing unit, a processing unit, a register unit, and at least one triggering unit. The image capturing unit is used for capturing image data; the processing unit is electrically connected to the image capturing unit and is used for executing a comparison procedure; the register unit is electrically connected to the processing unit and is configured with a determination logic; and the triggering unit is electrically connected to the processing unit, in which the processing unit runs the comparison procedure to compare an execution state of the triggering unit with the determination logic, and the processing unite controls an operation mode of the image capturing device according to the comparison procedure.

The disclosure also provides an electronic device, which comprises a main body and an image capturing device. The image capturing device is connected to one side of the main body, and comprises an image capturing unit, a processing unit, a register unit and at least one triggering unit. The image capturing unit is used for capturing image data; the processing unit is electrically connected to the image capturing unit and is used for executing a comparison procedure; the register unit is electrically connected to the processing unit and is configured with a determination logic; and the triggering unit is electrically connected to the processing unit, in which the processing unit runs the comparison procedure to compare an execution state of the triggering unit with the determination logic, and controls an operation mode of the image capturing device accordingly.

The disclosure further provides a control method of an operation mode The steps involves receiving an execution state , comparing the execution state with a determination logic; outputting a determination result after the comparison, and executing an operation mode according to the determination result.

In the control method according to the disclosure, the execution state comprises a first state which is confirmed after triggering is continued in a continuous time interval.

In the control method according to the disclosure, the execution state comprises a second state which is confirmed after the triggering is triggered for several times, and the time interval between the triggering at each time is smaller than a first predetermined time interval.

In the control method according to the disclosure, the operation mode comprises a first mode and a plurality of second modes, in which the first mode and the second modes are respectively executed by a single triggering, and the time interval between two adjacent single triggerings is longer than a second predetermined time interval.

Therefore, through the image capturing device and the electronic device using the image capturing device according to the disclosure, the processing unit may perform the comparison procedure to compare the execution state of the triggering unit with the determination logic stored in the register unit, and controls the operation mode of the image capturing device accordingly. In addition, through the control method of the operation mode according to the disclosure, after the execution state is compared with the determination logic, the corresponding operation mode is decided, and thus, not only the complexity of the image capturing device and the electronic device using the image capturing device may be effectively reduced, but also the user may easily and conveniently perform image post-process and special effect change.

### BRIEF DESCRIPTION OF THE DRAWINGS

The disclosure will become more fully understood from the detailed description given herein below for illustration only, and thus are not limitative of the disclosure, and wherein:

FIG. 1 illustrates an image capturing device according to a first embodiment of the disclosure;

FIG. 2 is a schematic view of an execution state according to the first embodiment of the disclosure;

FIG. 3 is a schematic view of an operation mode according to the first embodiment of the disclosure;

FIG. 4A and FIG. 4B illustrate an electronic device according to a second embodiment of the disclosure;

FIG. 5 is a flow chart of a control method of an operation mode according to a third embodiment of the disclosure;

FIG. 6 is a schematic view of an execution state according to the third embodiment of the disclosure; and

FIG. 7 is a schematic view of an operation mode according to the third embodiment of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

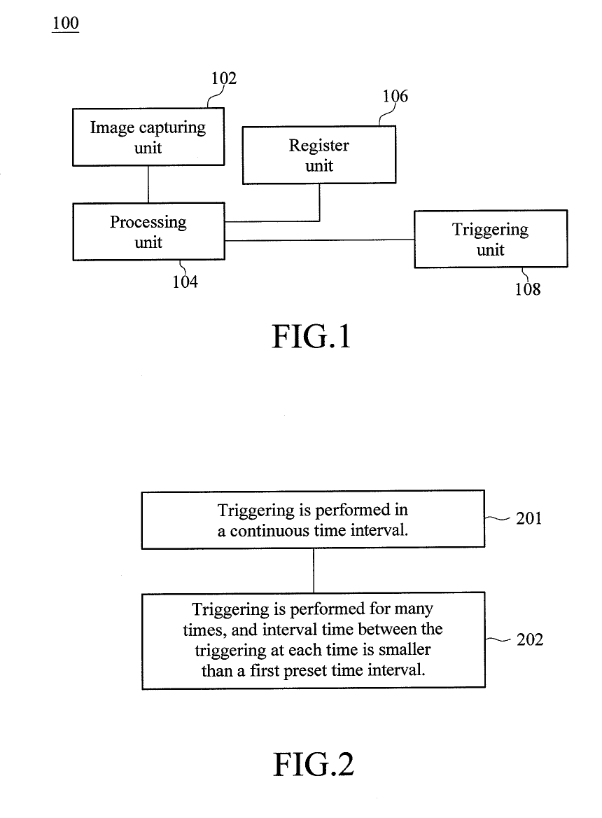

FIG. 1 illustrates an image capturing device 100 according to a first embodiment of the disclosure, in which the image capturing device 100 may be a digital still camera, a digital video camera, a web camera or an electronic product integrated with a digital image capturing function, such as a cell phone or a Personal Digital Assistant (PDA). The image capturing device 100 comprises an image capturing unit 102, a processing unit 104, a register unit 106, and at least one triggering unit 108. The image capturing unit 102 according to the first embodiment of the disclosure is, for example, an image sensor applicable to the web camera, but is not limited thereto. The common image capturing unit 102 may be, but is not limited to, a Charge-coupled Device (CCD).

Since the image capturing unit 102 has a plurality of sensing pixels, and the sensing pixel may be used for receiving light rays transmitted from a scene and converting the scene into corresponding image data by using photoelectric conversion, so that the image capturing device 100 may output the image data and presents the image on a display device thereof (for example, a screen) through the photoelectric conversion procedure of the image capturing unit 102.

The processing unit 104 is electrically connected to the image capturing unit 102, and may be used for executing a comparison procedure to compare an execution state of the triggering unit with the determination logic, all of which will be explained later. The processing unit 104 may be, but is not limited to, a Digital Signal Processor (DSP).

The register unit 106 is electrically connected to the processing unit 104. The register unit 106 is configured with a determination logic. The register unit 106 may be, but is not limited to, a flash memory. Therefore, a user may write a firmware program of the determination logic into the register unit 106 through an input interface connected to the image capturing device 100, so as to store the determination logic in the register unit 106.

The triggering unit 108 is electrically connected to the processing unit 104, and may be a button configured on a housing of the image capturing device 100, or a button embedded into the image capturing device 100. A shape, an appearance or a configuration manner corresponding to the image capturing device 100 of the triggering unit 108 shall not limit a scope of the disclosure. As long as the user can enable the processing unit 104 to perform the comparison procedure to compare the execution state of the triggering unit 108 with the determination logic by changing the execution state of the triggering unit 108, and control the operation mode of the image capturing device 100 accordingly, the manners fall within the protection scope of the disclosure.

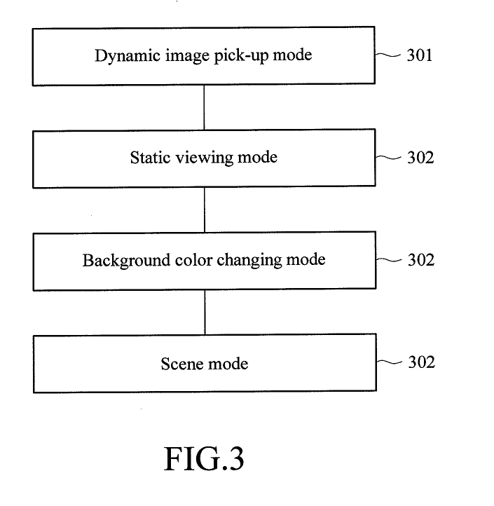

For example, as shown in FIG. 2, the execution state of the triggering unit 108 may comprise a first state 201 and/or a second state 202. The first state 201 is formed after the triggering unit 108 is triggered during a continuous time interval, and the second state 202 is formed after triggering of the triggering unit 108 is performed for several times and interval time between the triggering at each time is smaller than a first predetermined time interval. The continuous time interval and the first predetermined time interval may be set by the user, and according to the first embodiment of the disclosure, the continuous time interval may be, but is not limited to, three seconds, and the first predetermined time interval may be, but is not limited to, one second.

Specifically, when the triggering unit 108 forms the first state 201 or the second state 202 through different triggering manners, the processing unit 104 may run the comparison procedure to compare the execution state of the triggering unit 108 with the determination logic stored in the register unit 106. Afterwards, the processing unit 104 controls the operation mode of the image capturing device 100 according to a comparison result of the comparison procedure.

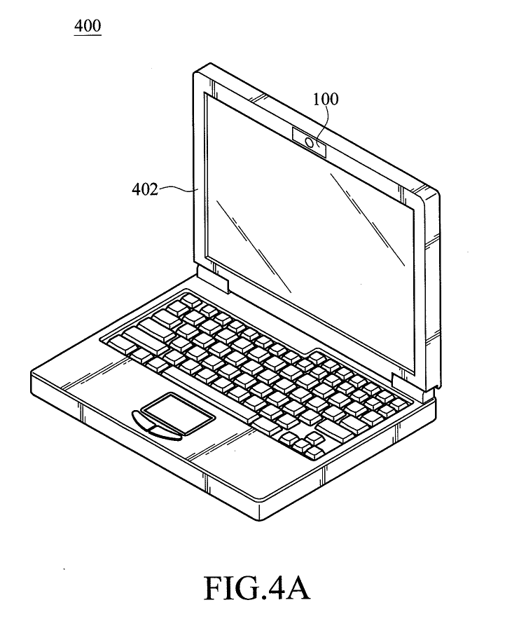

For example, referring to FIG. 3, the operation mode of the image capturing device 100 may comprise a first mode 301 and a plurality of second modes 302, in which the first mode 301 and the second modes 302 need to be respectively executed through the single triggering of the triggering unit 108, and interval time between the single triggering is larger than a second predetermined time interval. According to the previous embodiment, the second time interval may also be set by the user, and may be set to a value equal to the first predetermined time interval (for example, 1 second). In the case, when the triggering unit 108 generates triggers in the continuous time interval (for example, 3 seconds), or generates triggers for many times and the time interval between two adjacent single triggers at each time is smaller than the first predetermined time interval (for example, 1 second), or generates triggers for many times and the time interval between two adjacent triggers at each time is larger than the second predetermined time interval (for example, 1 second), the processing unit 104 may determine the operation mode and control the corresponding operation mode of the image capturing device 100 according to the execution states of the triggering unit 108.

The operation mode of the image capturing device 100 comprises the first mode 301 and the plurality of second modes 302, which are different from each other. Generally speaking, the operation mode (the first mode 301 and the plurality of second modes 302) of the image capturing device 100 may be a dynamic image catching mode, a static viewing mode, a background color changing mode, a scene (for example, a theater or a movie) mode, or other image special effect modes. Therefore, according to the first embodiment of the disclosure, corresponding to the different operation modes (the dynamic image catching mode, the static viewing mode, the background color changing mode, the scene mode, or other image special effect modes) of the image capturing device 100, the execution states of the triggering unit 108 may also be set by the user, and a corresponding relation thereof is not used to limit the scope of the disclosure.

Therefore, through the image capturing device according to the first embodiment of the disclosure, the user may enable the image capturing device to be correspondingly switched into different operation modes by changing the execution state of the triggering unit. Therefore, through the image capturing device according to the first embodiment of the disclosure, not only the complexity of the conventional image capturing device is reduced, but also the user may easily and conveniently change the operation mode of the image capturing device.

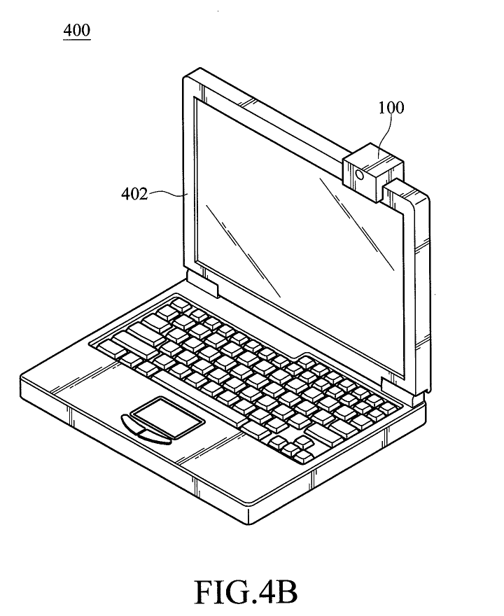

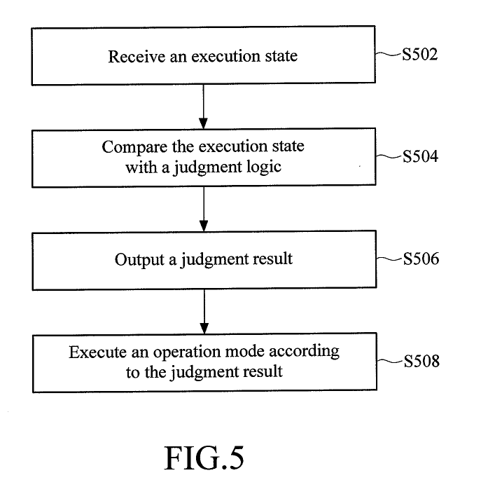

FIG. 4A and FIG. 4B illustrate an electronic device according to a second embodiment of the disclosure. Referring to FIG. 4A and FIG. 4B, the electronic device 400 comprises a main body 402 and an image capturing device 100, in which the image capturing device 100 is the same as or similar to the device described in the first embodiment, and is not described herein again accordingly. It should be noted that, the image capturing device 100 is connected to one side of the main body 402. According to the first embodiment, the image capturing device 100 is, for example, a web camera, that is to say, the image capturing device 100 may be embedded into the main body 402 as shown in FIG. 4A, or may be configured on an outer side of the main body 402 as shown in FIG. 5A. According to the second embodiment of the disclosure, the electronic device 400 may be a notebook, a Personal Computer (PC), or an electronic product integrated with a digital image capturing function, for example, a cell phone or other digital versatile devices.

FIG. 5 is a flow chart of a control method of an operation mode according to a third embodiment of the disclosure, in which the control method of the operation mode comprises steps S502, S504, S506 and S508. According to the third embodiment of the disclosure, the control method of the operation mode is applicable to an image capturing device, for example, a digital still camera, a digital video camera, a web camera or an electronic product integrated with a digital image capturing function, such as a cell phone or a PDA.

First, in step S502, the image capturing device receives an execution state, and then in step S504, compares the received execution state with a determination logic. Afterwards, as shown in step S506, the image capturing device outputs a determination result. Finally, as shown in step S508, the image capturing device executes a corresponding operation mode of the image capturing device according to the determination result obtained in step S506.

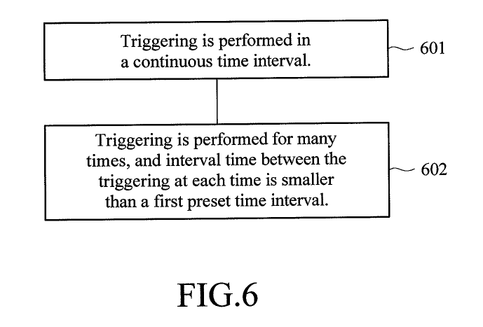

As for step S502, referring to FIG. 6, the execution state may comprise a first state 601 and a second state 602, in which the first state 601 may be formed after the image capturing device is triggered in a continuous time interval, and the second state 602 may be formed after the image capturing device is triggered for many times and the time interval between two adjacent triggers at each time is smaller than a first predetermined time interval. The continuous time interval and the first predetermined time interval may be set by the user, and according to the third embodiment of the disclosure, the continuous time interval may be, but is not limited to, 3 seconds, and the first predetermined time interval may be, but is not limited to, 1 second.

That is to say, through the control method of the operation mode according to the third embodiment of the disclosure, the image capturing device forms different execution states through different triggering conditions. Afterwards, according to comparison results between the different execution states and the determination logic, the determination result is output, and the image capturing device executes the corresponding operation mode according to the result.

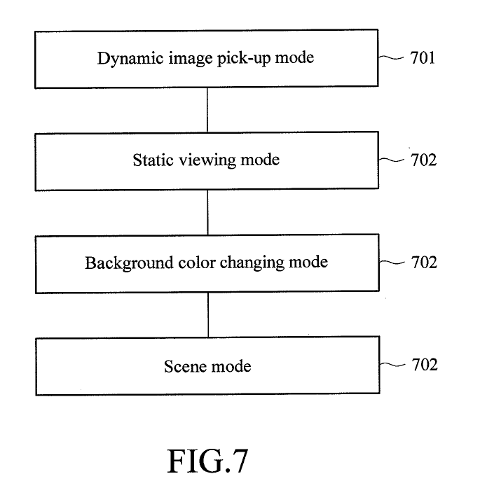

For example, referring to FIG. 7, the operation mode of the image capturing device may comprise a first mode 701 and a plurality of second modes 702, in which the first mode 701 and the second modes 702 need to be respectively executed through single triggering, and the time interval between two adjacent triggers is larger than a second predetermined time interval. According to the previous embodiment, the second time interval may also be set by the user, and may be set to a value equal to the first predetermined time interval (for example, 1 second). In the case, when the image capturing device receives the triggering in the continuous time interval (for example, 3 seconds), or receives the triggering for many times and the interval time between two adjacent triggers at each time is smaller than the first predetermined time interval (for example, 1 second), or receives the triggering for many times and the interval time between two adjacent triggers at each time is larger than the second predetermined time interval (for example, 1 second), the image capturing device may compare the execution state with the determination logic according to the different execution states, and decides and executes the corresponding operation mode of the image capturing device according to the determination result.

The operation modes (the first mode 701 and the plurality of second modes 702) are different from each other. The operation mode may be a dynamic image catching mode, a static viewing mode, a background color changing mode, a scene (for example, a theater or a movie) mode or other image special effect modes. Therefore, through the control method of the operation mode according to the third embodiment of the disclosure, the image capturing device receives different execution states to execute different operation modes (for example, the dynamic image catching mode, the static viewing mode, the background color changing mode, the scene mode or other image special effect modes). The execution state and the corresponding operation mode may also be set by the user, and a corresponding relation thereof is not used to limit the scope of the disclosure.

Therefore, through the image capturing device according to the first embodiment, the electronic device according to the second embodiment and the control method of the operation mode according to the third embodiment of the disclosure, the user can enable the image capturing device to execute different operation modes according to different execution states, and thus, not only the complexity of the conventional image capturing device and the electronic device using the image capturing device is reduced, but also the user may easily and conveniently change the operation mode and perform special effect post-process on the output frame.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image capturing device, comprising:
an image capturing unit, used for capturing image data;
a processing unit, electrically connected to the image capturing unit, and executing a comparison procedure;
a register unit, electrically connected to the processing unit, and configured with a determination logic; and
at least one triggering unit, electrically connected to the processing unit, wherein the processing unit runs the comparison procedure to compare an execution state of the triggering unit with the determination logic, and the processing unit controls an operation mode of the image capturing device according to the comparison procedure.

2. The image capturing device according to claim 1, wherein the execution state comprises a first state generated by the triggering unit triggered during a continuous time interval.

3. The image capturing device according to claim 1, wherein the execution state comprises a second state generated by the triggering unit triggered for several times, and the time interval between two adjacent triggerings is smaller than a first predetermined time interval.

4. The image capturing device according to claim 1, wherein the operation mode comprises a first mode and a plurality of second modes, the first mode and the second modes are respectively executed by a single triggering, and the time interval between two adjacent triggerings is longer than a second predetermined time interval.

5. The image capturing device according to claim 4, wherein the plurality of the second modes are different from each other.

6. The image capturing device according to claim 1, wherein the operation mode comprises a third mode and a fourth mode, and the third mode is an image catching mode, and the fourth mode is a viewing mode.

7. An electronic device, comprising:
a main body; and
an image capturing device, connected to one side of the main body, and comprising:
an image capturing unit, used for capturing image data;
a processing unit, electrically connected to the image capturing unit, and used for executing a comparison procedure;
a register unit, electrically connected to the processing unit, and configured with a determination logic; and
at least one triggering unit, electrically connected to the processing unit, wherein the processing unit runs the comparison procedure to compare an execution state of the triggering unit with the determination logic, and the processing unit controls an operation mode of the image capturing device according to the comparison procedure.

8. The electronic device according to claim 7, wherein the execution state comprises a first state generated by the triggering unit triggered in a continuous time interval.

9. The electronic device according to claim 7, wherein the execution state comprises a second state generated by the triggering unit triggered for several times, and the time interval between two adjacent triggering is smaller than a first predetermined time interval.

10. The electronic device according to claim 7, wherein the operation mode comprises a first mode and a plurality of second modes, the first mode and the second modes are respectively executed by a single triggering, and the time interval between two adjacent triggerings is larger than a second predetermined time interval.

11. The electronic device according to claim 10, wherein the plurality of the second modes are different from each other.

12. The electronic device according to claim 7, wherein the operation mode comprises a third mode and a fourth mode, the third mode is an image catching mode, and the fourth mode is a viewing mode.

13. A control method of an operation mode, comprising:
receiving an execution state;
comparing the execution state with a determination logic;
outputting a determination result; and
executing an operation mode according to the determination result.

14. The control method according to claim 13, wherein the execution state comprises a first state generated from triggering in a continuous time interval.

15. The control method according to claim 13, wherein the execution state comprises a second state generated from triggering performed for several times, and the time interval between two adjacent triggerings is smaller than a first predetermined time interval.

16. The control method according to claim 13, wherein the operation mode comprises a first mode and a plurality of second modes, the first mode and the second modes are respectively executed by a single triggering, and the time interval between two adjacent triggerings is larger than a second predetermined time interval.

17. The control method according to claim 16, wherein the plurality of the second modes are different from each other.

18. The control method according to claim 13, wherein the operation mode comprises a third mode and a fourth mode, the third mode is an image catching mode, and the fourth mode is a viewing mode.
